(19) United States
(12) Patent Application Publication
(10) Pub. No.: US 2011/0231482 A1
(43) Pub. Date: Sep. 22, 2011

(54) Automated Optimization Based On Determination Of Website Usage Scenario

(75) Inventor: Michael R. Benna, Vancouver (CA)

(73) Assignee: STRANGELOOP NETWORKS INC., Vancouver (CA)

(21) Appl. No.: 13/051,887

(22) Filed: Mar. 18, 2011

Related U.S. Application Data
(60) Provisional application No. 61/316,166, filed on Mar. 22, 2010.

(51) Int. Cl. G06F 15/16

(52) U.S. Cl. 709/203

(57) ABSTRACT

Response time improvement methods are optimized by enabling an optimizer to determine the probable state of a client's local cache. Knowledge of the client's local cache can be used for determining which type of optimization techniques, if any, should be applied. In one embodiment, the system distinguishes between at least two user scenarios that may benefit from different types of optimization, such as for example a first-time user and a returning user. Different types of optimization can be performed depending on the identified scenario. For example, for a first-time user of a website, a server can bundle external resources with the initial response. Such an optimization reduces or eliminates the need for additional client requests to render the page. In returning user view scenarios where external resources may have already been cached, redundant retransmission of such information can be avoided.

### CROSS-REFERENCE TO RELATED APPLICATIONS

The present application claims priority from U.S. Provisional Application Ser. No. 61/316,166 for “Automated Landing Page Optimization,” (Atty. Docket No. STR019-PROV), filed Mar. 22, 2010, the disclosure of which is incorporated herein by reference.

The present application is related to U.S. Utility application Ser. No. 12/426,909 for “Extensible, Asynchronous, Centralized Analysis and Optimization of Server Responses to Client Requests,” (Atty. Docket No. STR018), filed Apr. 20, 2009, the disclosure of which is incorporated herein by reference.

### FIELD OF THE INVENTION

The present invention relates to optimizing performance and response time when presenting content in a client/server environment.

### BACKGROUND

In systems wherein servers provide responses to client requests across a network such as the Internet, it is generally desirable to minimize the time required to fulfill each request. One cause of delayed request fulfillment is the fact that an initial client request may spawn additional requests that must all be fulfilled before the initial request can be fulfilled. For example, a request for a Web page often spawns additional requests for resources, such as images, scripts and style sheets, which the client requires when rendering the Web page.

Various methods can be employed, both at clients and servers, in an effort to help minimize the time required for fulfillment of client requests. One commonly used technique is to cache resources locally at client machines. Local caching enables clients that have already received resources in response to previous requests to reuse those resources rather than making additional requests to the server for those resources. As another example, servers can bundle resources into initial responses, reducing or eliminating the need for clients to make additional separate requests for resources.

The effectiveness of such performance improvement attempts can depend on many factors, including the current state of the client. For example, if a client has previously cached resources relevant to a particular website, it may be counterproductive for a server to bundle additional resources with a response, because the client already has those resources. The extra bandwidth required to bundle the additional resources can actually hamper performance (and deleteriously affect response time) rather than improving it.

Generally, servers do not have adequate information as to the current state of a particular client to adequately optimize performance improvement techniques. Without such state information, servers are generally not able to determine which type of response time improvement method(s), if any, should be applied when responding to a particular request. Specifically, for example, servers may not be able to determine whether it would be beneficial, when transmitting a particular response to a client, to bundle additional resources with the response. Thus, the server's lack of information as to the client's current state may limit the effectiveness of response time improvement methods.

### SUMMARY

According to various embodiments of the present invention, response time improvement methods are optimized by enabling an optimizer to determine the probable state of a client's local cache. The optimizer can be located on a server, at a proxy or independent acceleration engine (accelerator), or at any other device that can intercept, monitor, route, or otherwise process requests and/or responses. Knowledge of the client's local cache is used to help determine which type of optimization techniques, if any, should be applied.

In a web application, for example, first-time users of a website do not have locally cached resources from that site. To improve performance in fulfilling future requests from these users, a server can minimize the number of required additional requests for resources by bundling resources with the initial response. The user's browser renders the first page visited on the site, referred to herein as the “landing page.” Resources that are likely to be required for fulfilling future requests for other pages on the site or for repeat visits to the landing page can be cached at the client for future use.

In one embodiment, the subject invention distinguishes between at least two user scenarios that may benefit from different types of optimization. For example and without limitation, the following user scenarios may be recognized:
first-time user, or “landing page” scenario (server is not aware of any previous visit by this user);
returning user, or “repeat view” scenario (server recognizes that this user has previously visited the website).

Different types of optimization can be performed depending on the identified scenario. For example, in one embodiment, if the first-time user scenario is identified, the server embeds external resources directly into the response without regard for whether such resources may already be available from the client's local cache. Such an optimization reduces or eliminates the need for additional client requests to render the page. In addition, in one embodiment, once such resources have been received, the client's local cache can be preloaded with commonly-used resources in preparation for future requests.

In one embodiment, if the returning user scenario is identified, the system can avoid bundling resources that are likely to have been previously cached. Non-common resources can be included inline in the response, on a page-by-page basis. Such non-common resources can include those resources that are not likely to have been previously cached by the client since they were not provided during the previous visit. In one embodiment, the non-common resources are provided in consolidated form. The client uses the local cache to optimize access to previously loaded resources and/or to preload additional commonly-used resources in preparation for future requests.

One skilled in the art will recognize that the automated optimization techniques described herein can be applied to other scenarios and conditions, and is not limited to the specific examples discussed herein.

### BRIEF DESCRIPTION OF THE DRAWINGS

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention. In particular, the sequence diagrams provided herein are intended to show an example of a particular sequence of events that can be used to implement the invention. One skilled in the art will recognize, however, that the events can take place in a different sequence, and/or that some events can be omitted and/or others added, without departing from the essential characteristics of the invention as set forth in the claims.

FIG. 1A depicts an architecture for practicing the present invention according to one embodiment, wherein an optimizer resides in a network device such as a router.

FIG. 1B depicts an architecture for practicing the present invention according to one embodiment, wherein an optimizer resides in a server.

FIG. 2 is a block diagram depicting an architecture for an optimizer according to one embodiment of the present invention.

FIG. 3 is a flow diagram depicting various use cases and activities associated with the invention.

FIG. 4 is a sequence diagram illustrating a method of detecting a user context scenario according to one embodiment.

FIG. 5 is a sequence diagram illustrating a method of detecting a user context scenario, wherein the presence or absence of a cookie is used to determine whether the user has previously visited a website, according to one embodiment.

FIG. 6 is a sequence diagram illustrating a method of detecting a user context scenario, wherein an HTTP referrer header is used to determine whether the user has previously visited the website, according to one embodiment.

FIG. 7 is a sequence diagram illustrating a method of detecting a user context scenario, wherein a configurable HTTP header is used to determine whether the user has previously visited a website, according to one embodiment.

FIG. 8 is a sequence diagram illustrating a method of detecting a user context scenario, wherein an ETag is used to determine whether the user has previously visited a website, according to one embodiment.

FIG. 9 is a sequence diagram illustrating the use of a user context scenario detection mechanism within an acceleration environment, wherein the user is a first-time user, according to one embodiment.

FIG. 10 is a sequence diagram illustrating the use of a user context scenario detection mechanism within an acceleration environment, wherein the user is a returning user, according to one embodiment.

### DETAILED DESCRIPTION OF THE EMBODIMENTS

In the examples and drawings presented herein, the present invention is described in connection with mechanisms for optimizing HTTP response messages, such as HTML messages transmitted over the Internet in response to client requests. Particular examples are set forth in which a user accesses a website via client software such as a browser. However, one skilled in the art will recognize that the methods of the present invention can also be applied to other forms of optimization and to systems using protocols other than HTTP. In addition, in various examples, the present invention is described herein as a mechanism for detecting user context so as to determine which of a plurality of optimization methods should be used in responding to a client request, so as to improve response time; however, in other embodiments the present invention can be used to achieve other optimization goals.

### System Architecture

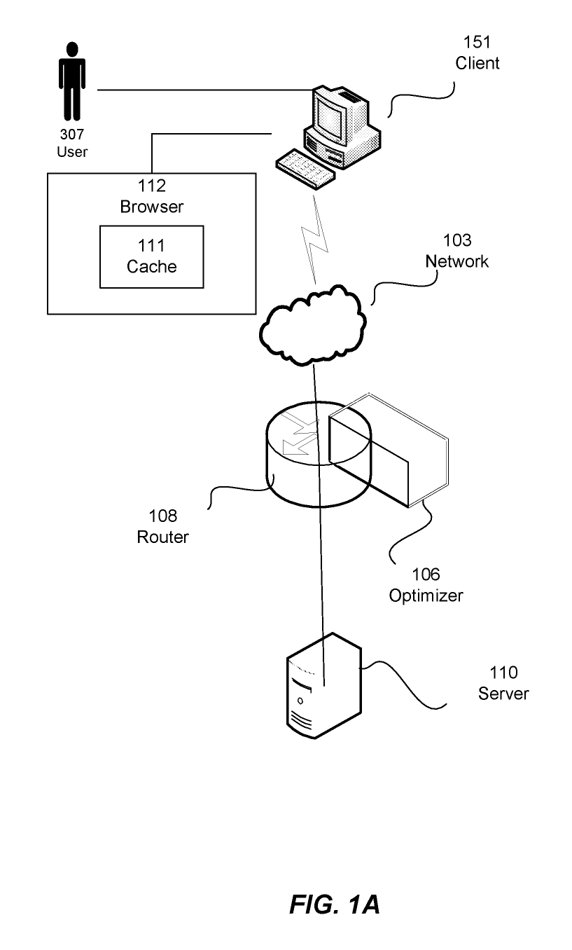

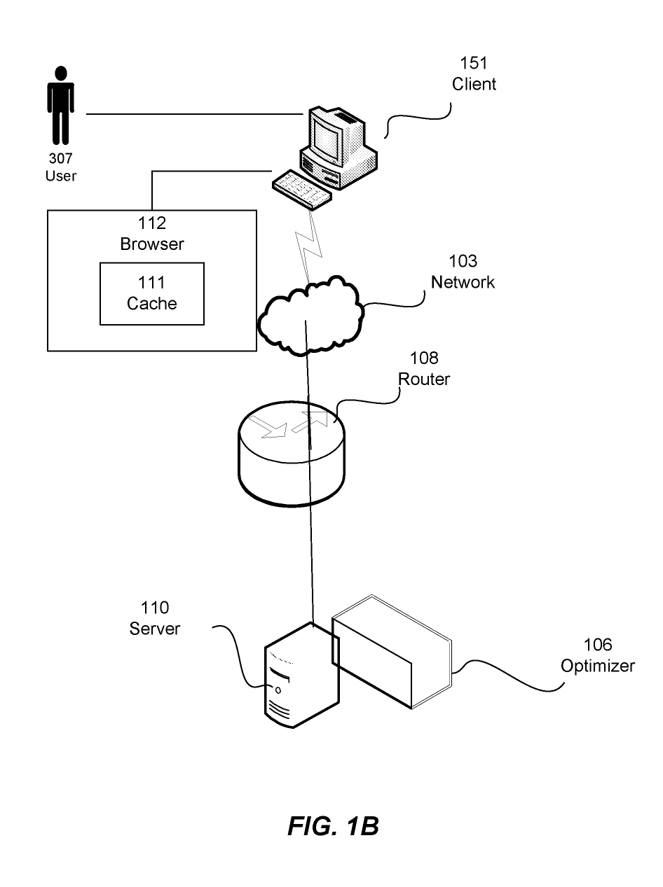

Referring now to FIG. 1A, there is shown an architecture for practicing the present invention according to one embodiment, wherein an optimizer 106 for performing the techniques of the present invention resides in a network device such as router 108. As depicted in FIG. 1A, in such a configuration, optimizer 106 is positioned between server 110, which may be an HTTP server or other server, and client machine 151, which may be an HTTP client or any electronic device capable of sending and receiving messages on network 103. Network 103 may be the Internet or any other network enabling communication among two or more electronic devices. Network 103 may be implemented using well-known network protocols such as Hypertext Transfer Protocol (HTTP), Secure Hypertext Transfer Protocol (SHTTP), Transmission Control Protocol/Internet Protocol (TCP/IP), and/or the like. In some embodiments, secure access to network 103 may be facilitated via well known techniques such as a Virtual Private Network (VPN), although such secure access is not required.

Client 151 and/or server 110 may be computers or any other electronic devices. Examples include, without limitation, a desktop computer, laptop computer, personal digital assistant (PDA), cellular telephone, smartphone, music player, handheld computer, tablet computer, kiosk, game system, enterprise computing system, server computer, or the like. In one embodiment, client 151 and/or server 110 are desktop computers running an operating system such as for example: Linux; Microsoft Windows, available from Microsoft Corporation of Redmond, Wash.; Mac OS X, available from Apple Inc. of Cupertino, Calif.; iOS, available from Apple Inc. of Cupertino, Calif.; and/or any other operating system that is adapted for use on such devices. In one embodiment, client 151 includes local cache 111, which can be used for storing resources retrieved from server 110 for later use; cache 111 can be implemented at client 151 according to well-known methods.

In one embodiment, client 151 and/or server 110 each include a number of hardware components as are well known to those skilled in the art, including for example one or more input devices (such as a keyboard, mouse, touchscreen, trackball, trackpad, five-way switch, voice input device, joystick, and/or any combination thereof), one or more output devices (such as a screen, speaker, printer, and/or any combination thereof), one or more processors (which can be a conventional microprocessor for performing operations on data under the direction of software, according to well-known techniques), memory (such as random-access memory having a structure and architecture as are known in the art, for use by the one or more processors in the course of running software), and/or local storage (which can be any magnetic, optical, and/or electrical storage device for storage of data in digital form, such as flash memory, magnetic hard drive, CD-ROM, and/or the like). Such components are well known in the art of computing architecture and are thus omitted from FIG. 1A for clarity.

One skilled in the art will recognize that the particular arrangement of hardware elements shown in FIG. 1A is merely exemplary, and that the invention can be implemented using different hardware elements configured in any of a number of different ways. Thus, the particular architecture shown in FIG. 1A is merely illustrative and is not intended to limit the scope of the invention in any way.

One skilled in the art will recognize that any number of devices, singly or in any combination, may be configured to fulfill the roles of client 151 and/or server 110 described herein without departing from the scope of the present invention.

In one embodiment, client 151 operates under the direction and control of user 307, who interacts with client 151 via a user interface according to well-known techniques.

Client 151 may run web browser 112 and/or another software application for enabling network communications. For illustrative purposes, the invention is described herein in terms of a request for a web page issued by browser 112 running on client 151. In one embodiment, cache 111 is associated with browser 112, although cache 111 can separate from browser 112 and can be any local cache for use by client 151.

In one embodiment, router 108 is implemented as a computing device configured to route network traffic between client 151 and server 110 according to well known mechanisms. Router 108 may include optimization and acceleration components as described in related U.S. Utility application Ser. No. 12/426,909 for “Extensible, Asynchronous, Centralized Analysis and Optimization of Server Responses to Client Requests.” Such components may include, for example, optimizer 106 as described in the related application.

In one embodiment, optimizer 106 can be implemented as a software-based component of router 108. Accordingly, router 108 may include a processor (not shown) for performing the techniques of the present invention in accordance with software and/or firmware instructions.

Referring now to FIG. 1B, there is shown an architecture for practicing the present invention according to another embodiment, wherein optimizer 106 resides in server 110. One skilled in the art will recognize that the techniques of the present invention can be implemented in an optimizer 106 or other component having any suitable location within the overall network architecture, and that the particular arrangements shown in FIGS. 1A and 1B are merely exemplary.

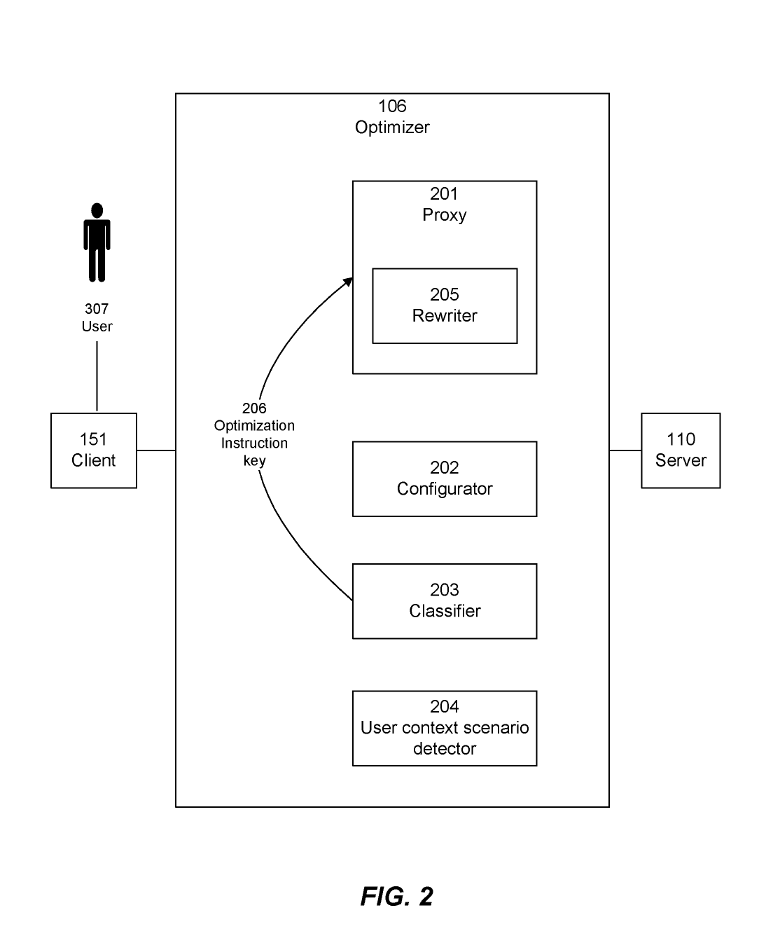

Referring now to FIG. 2, there is shown a block diagram depicting an architecture for optimizer 106 according to one embodiment of the present invention. The particular architecture depicted in FIG. 2 is merely exemplary, but can be implemented according to the techniques of the present invention regardless of whether optimizer 106 is situated within router 108, server 110, or at any other location in the network.

As shown in FIG. 2, in one embodiment optimizer 106 includes the following components:
proxy 201 for receiving and handling requests from client 151;
configurator 202 for providing information regarding particular site usage scenarios (for example, a list of personalized resources with special handling requirements);
classifier 203 for mapping URLs to URL classification keys;
user context scenario detector 204 for detecting a user context scenario by any of a number of different means.

In one embodiment, the classification key is implemented as an acceleration instruction key, or portion thereof, which operates as described in related U.S. Utility application Ser. No. 12/426,909. Additional fields can be added to the acceleration instruction key to implement the functionality of the invention described herein.

In one embodiment, proxy 201 includes rewriter 205 for applying optimization instructions to server responses.

Each of these components can be implemented using any combination of hardware, firmware, and software. For example, the components may be implemented as software modules for controlling the operation of a processor in optimizer 106.

### Overview of Method

In one embodiment, the system of the present invention uses an optimization framework in which detector 204 detects which of two (or more) usage scenarios, such as first-time user or returning user, is applicable. A first-time user, or first-time visitor to a website, is a user who is identified as having never previously visited the website. In some embodiments, certain users who have visited the website are still identified as first-time users, if certain circumstances exist, such as for example:
the user visited the website a long time ago, so that any information cached by the user's computer has been flushed or is likely out-of-date;
the user visited the website, but from a different client computer, so that any information cached during the previous visit is not available for this visit;
the user visited the website from the same client computer, but local cache 111 has been cleared in the interim;
the website has been significantly revised since the user's previous visit;
detector 204 detects some other circumstance, event, or condition that indicates that it would be beneficial to treat the user as a first-time user.

A returning user is a user who is identified as having previously visited the website, so that cached data for the website is (or is likely to be) available at the local cache.

In one embodiment, the scenario in which a first-time user is identified is referred to as a “landing page” scenario, referring to the fact that the requested page is the first page encountered within the website for that user. The scenario in which a returning user is identified is referred to as a “repeat view” scenario.

Configurator 202 and classifier 203 enable the use of different optimization instructions for the same page on the same site, depending on which scenario applies. Thus, one (or more) set of optimization instructions might be provided for each scenario. By performing automated optimization in this manner, the system of the present invention improves load times by reducing or eliminating inefficient compromises between resource-bundling and cache-populating techniques. In some embodiments, additional optimization instructions may be provided, such as for example consolidation of resources.

In one embodiment, detector 204 determines whether the page requested by client 151 is likely to be the first page encountered within the website for a particular user 307. This determination indicates whether the appropriate scenario is a “first-time user” (or “landing page”) scenario, or a “returning user” (or “repeat view”) scenario. In one embodiment, optimizer 106, or some other component, attaches a persistent cookie to all responses being sent to client 151. Subsequent requests from that client 151 include the cookie. Accordingly, detector 204 can check for the presence of the cookie to determine whether a particular page request is for a first-time user. If the cookie is not present, detector 204 assumes the request is from a first-time user (i.e., this is the first visit by this client 151 to this website, at least since the last time client's 151 cookies were cleared). Conversely, if the cookie is present, detector 204 assumes the request is from a returning user (i.e., the client 151 has previously visited the website containing this page). As described herein, other mechanisms can be used for detecting user context.

Rewriter 205 applies optimization instructions based on a determination as to which user context scenario is applicable. In one embodiment, any number of optimization instructions can be provided for servicing client 151 requests. Some optimization instructions may be useful in certain situations (or contexts) but not others. In one embodiment, a tag (which may be encoded as a bit, for example) is added to the key of each optimization instruction to indicate whether the instruction pertains to either a first-time user or a returning user. In one embodiment, therefore, the system can be configured so as to use optimization instructions only for the scenario that they have been created to address. For example, instructions that pertain to first-time user scenarios are only used when detector 204 determines that a particular requested page is for a first-time user.

One example of an optimization instruction that is useful for pages being sent to first-time users is an enhanced landing page consolidator instruction. In one embodiment, rewriter 205 includes a landing page consolidator (LPC), which bundles as many resources as possible directly into the page, possibly in consolidated form. After the page has fully rendered, embedded resources can be loaded into local cache 111 while user 307 is viewing the page. This prepares user's 307 session for the best possible repeat view experience.

In one embodiment, when responding to a request from a returning user, optimization is performed in a manner that improves consolidation of resources. In one embodiment, the system of the present invention includes functional components for implementing resource consolidation methods as described in related U.S. Utility application Ser. No. 12/426,909 for “Extensible, Asynchronous, Centralized Analysis and Optimization of Server Responses to Client Requests,” (Atty. Docket No. STR018), filed Apr. 20, 2009, the disclosure of which is incorporated herein by reference. In another embodiment, the described techniques are enhanced. For example, common resources can be preloaded, and resources unique to a given page or rarely used in other pages can be consolidated inline, for example in resource cabinets.

### Use Cases

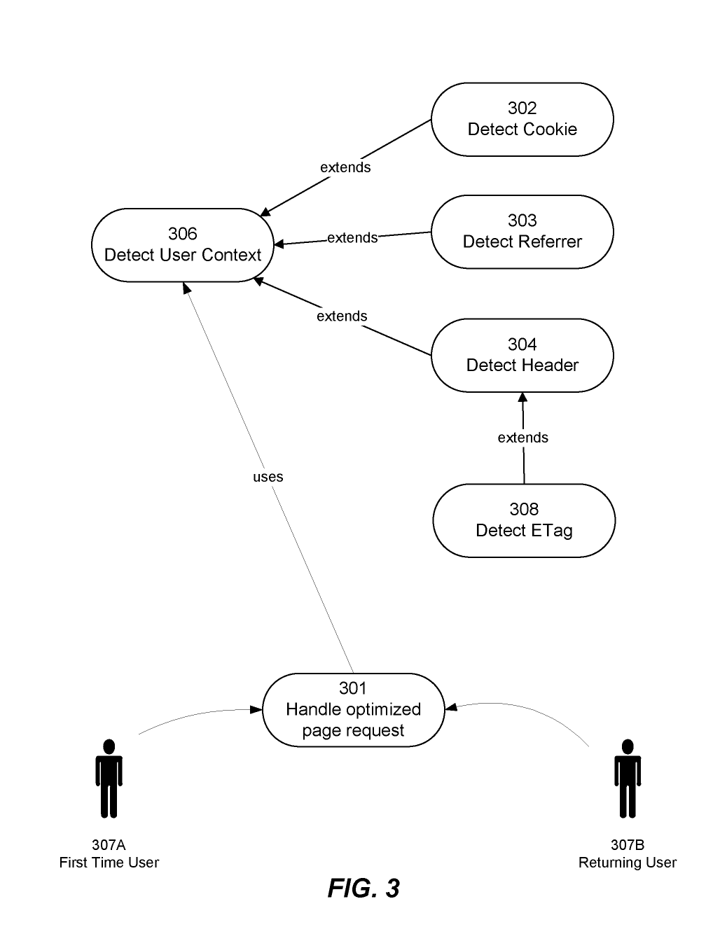

Referring now to FIG. 3, there is shown a flow diagram depicting various use cases and activities associated with the invention. As shown in the Figure, in one embodiment there are at least two user roles whose requests can be handled by the system of the present invention:
First-time user 307A: This role represents a person using browser 112 (or other software) to navigate to an optimized website for the first time, or for the first time since browser cache 111 has been flushed.
Returning user 307B: This role represents a person using browser 112 (or other software) to return to an optimized website that he or she has previously visited. Depending on configuration settings, this can represent a request for second (or later) page of the same website within the same browsing session or a subsequent browsing session. Alternatively, it can represent another view of the initial page after closing and reopening browser 112 without flushing cache 111. In general, the returning user role 307B represents a request for a page within the optimized website wherein the user has previously visited the website and cache 111 has not been flushed in the interim.

As discussed above, a user 307 who has visited the website may still be identified as a first-time user 307A, if certain circumstances exist, such as for example:
user 307 visited the website a long time ago, so that any information cached by the user's computer has been flushed or is likely out-of-date;
user 307 visited the website, but from a different client computer 151, so that any information cached during the previous visit is not available for this visit;
user 307 visited the website from the same client computer 151, but local cache 111 has been cleared in the interim;
the website has been significantly revised since user's 307 previous visit;
detector 204 detects some other circumstance, event, or condition that indicates that it would be beneficial to treat user 307 as a first-time user 307A.

One skilled in the art will recognize that the above are merely examples, and that other circumstances may exist where it is appropriate to treat a user 307 as a first-time user 307A even if the user 307 has previously visited the website.

In various embodiments, the system of the present invention is able to handle various use cases as depicted in FIG. 3. The following use cases are depicted:
Handle Optimized Page Request 301 is the parent use case in which optimizer 106 generates instructions so that the page request can be handled in an optimized manner. In one embodiment, this use case involves the use of classifier 203 to map classification keys, and detector 204 to detect a user context scenario. In accordance with the operations of these components, an acceleration instruction key appropriate to the current situation is obtained and applied. This key references an acceleration instruction that has been tailored for the specific website usage scenario.
Detect User Context 306 is the generalized use case for all forms of user context detection according to one embodiment, regardless of the underlying mechanism. Any of a number of user context detection mechanisms can be used, singly or in any combination. Certain of these mechanisms will be described in more detail herein. In particular, four specific mechanisms are depicted in FIG. 3:
   Detect Cookie Context 302: In this case, an HTTP cookie value is used to indicate whether or not user 307 has previously visited the website, causing local cache 111 to have been populated with resource data. The cookie value, the requested URL, and the configuration data are combined to create a key that identifies the acceleration scenario. In one embodiment, the cookie can also be used to indicate the date and time of user's 307 last visit to the website; such information can be used to make a determination as to whether any information at local cache 111 is likely to be up-to-date and valid with respect to the website.
   Detect Referrer Context 303: In this case, an HTTP referrer header value is used to indicate whether or not user 307 has previously visited the website. The referrer header value, the requested URL, and the configuration data are combined to create a key that defines the acceleration scenario.
   Detect Header Context 304: In this case, a configurable header value managed by server 110 is used to indicate whether or not user 307 has previously visited the website. The header value, the requested URL, and the configuration data are combined to create a key that defines the acceleration scenario.
   Detect HTTP ETag 308: As a specialized case of Detect Header Context 304, an ETag, or entity tag, can be detected to determine whether local cache 111 contains up-to-date data for the website. This determination, along with the requested URL and the configuration data, are used to create a key that defines the acceleration scenario.

### General Method for Detecting User Context Scenario

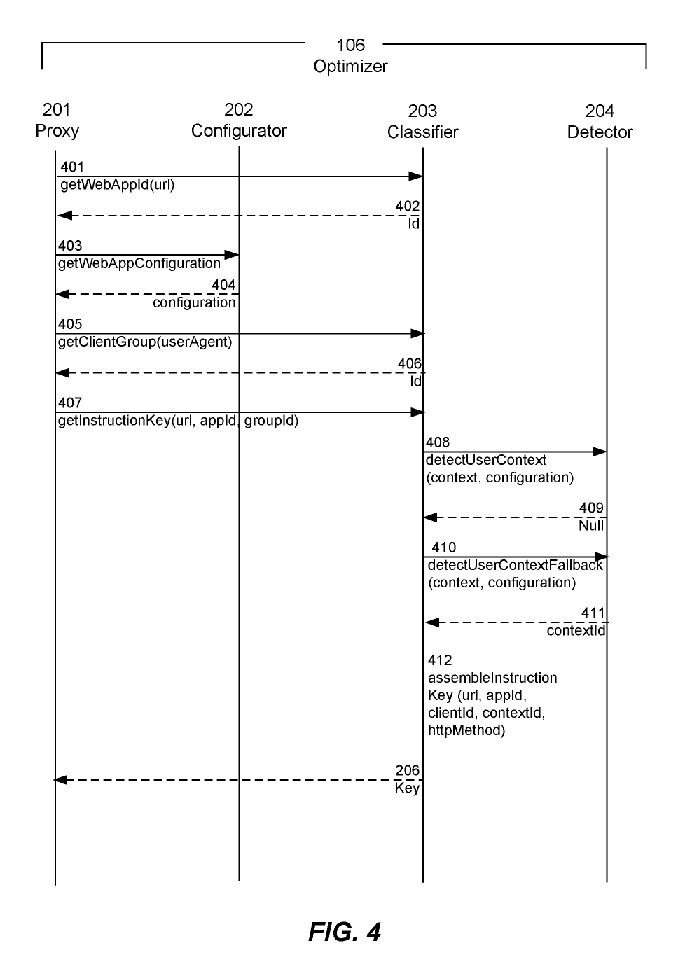

Referring now to FIG. 4, there is shown a sequence diagram illustrating in more detail the operations that optimizer 106 performs according to one embodiment, so as to generate optimization instruction key 206 that is used for determining which type of optimization to use. Browser 112 context is used to establish whether the client's local cache 111 is primed (i.e., contains resource information relevant to the website) or not. The Figure depicts various steps performed by proxy 201, configurator 202, classifier 203, and user context scenario detector 204.

Optimization instruction key 206 specifies which optimization instruction(s) (or acceleration template) proxy 201 should use for a given page when viewed in a given scenario. In one embodiment, only the first-time user and returning user view scenarios are detected, but other embodiments can include differentiations for additional client state scenarios. In one embodiment, rewriter 205 component of proxy 201 rewrites server responses so as to apply optimization instruction(s) as specified by key 206.

Proxy 201 requests 401 an identifier from classifier 203 for the particular web application being requested. In one embodiment, classifier 203 indexes web applications according to URL; thus, the request for the identifier includes the URL. Classifier 203 responds to the request, providing proxy 201 with the web application identifier 402.

Proxy 201 then requests 403 information from configurator 202 as to the configuration of the web application. Configurator 202 replies with the configuration information 404 used during the application of any optimizations. Such configuration information 404 can include, for example, any information specific to the website, such as a list of resources to treat in some special way, or the domain name to use for certain optimized resources or the like.

Next, proxy 201 optionally requests 405, from classifier 203, a client group identifier for the particular client 151 making the request. Classifier 203 responds with the client group identifier 406. A client group is a group of browsers that behave similarly enough that custom optimizations can be specified for application to all browsers within the particular group. For example, Internet Explorer 7 (of which there are many sub-versions) may contain a specific set of features that facilitate the use of a particular optimization; thus, in one embodiment, a client group identifier “IE7” may be specified to refer to a client group that includes all versions of Internet Explorer 7. Similarly, client groups can be defined and client group identifiers specified for other groups of browsers such as Chrome, Firefox, Internet Explorer 6, Internet Explorer 8, Internet Explorer 9, Safari, and the like.

Proxy 201 then requests 407 an instruction key from classifier 203, based on the URL of the requested resource, application identifier 402, and client group identifier 406. Classifier 203 sends a message 408 to detector 204, requesting that it detect user context for the resource request. In one embodiment, classifier 203 passes the determined configuration 404 to detector 204, and detector 204 responds by returning a null message 409 while passing the context data back to classifier 203. In one embodiment, if a first attempt to detect user context fails, classifier 203 passes a fallback request 410 to detector 204, which causes detector 204 to attempt to detect context by some other method. In one embodiment, any number of fallback mechanisms can be used; once classifier 203 obtains a usable context identifier 411 (or exhausts known mechanisms for attempting to detect context), it stops trying other fallback mechanisms. Fallback mechanisms can be omitted, if desired.

In one embodiment, the fallback mechanism is implemented within detector 204, so that classifier 203 need not issue multiple calls to cause fallback methods to be attempted. Accordingly, in such an embodiment, classifier 203 issues detect user context call 408 to detector 204, and detector 204 attempts any number of mechanisms for detecting user context before returning a context identifier 411.

Classifier 203 uses the obtained context identifier 411, URL of the requested resource, application identifier 302, configuration 404, client group identifier 405, and HTTP method to assemble 412 an instruction key 206. In one embodiment, instruction key 206 is generated according to techniques for identifying an instruction library index as described in related U.S. Utility application Ser. No. 12/426,909 for “Extensible, Asynchronous, Centralized Analysis and Optimization of Server Responses to Client Requests.” In one embodiment, classifier 203 takes into account additional information, such as for example a determination as to whether user 307 may have turned off cookies at client 151 and/or disabled cache 111.

Instruction key 206 is transmitted to proxy 201 for use in responding to client 151 request. In one embodiment, instruction key 206 specifies whether or not to include, in the response to the client 151 request, additional resources for populating local cache 111 of client 151. In other embodiments, instruction key 206 may specify additional instructions to be performed in responding to the request, as described in related U.S. Utility application Ser. No. 12/426,909 for “Extensible, Asynchronous, Centralized Analysis and Optimization of Server Responses to Client Requests.” In one embodiment, proxy 201 includes rewriter 205, which rewrites the response in accordance with instruction key 206.

### Cookie Detection

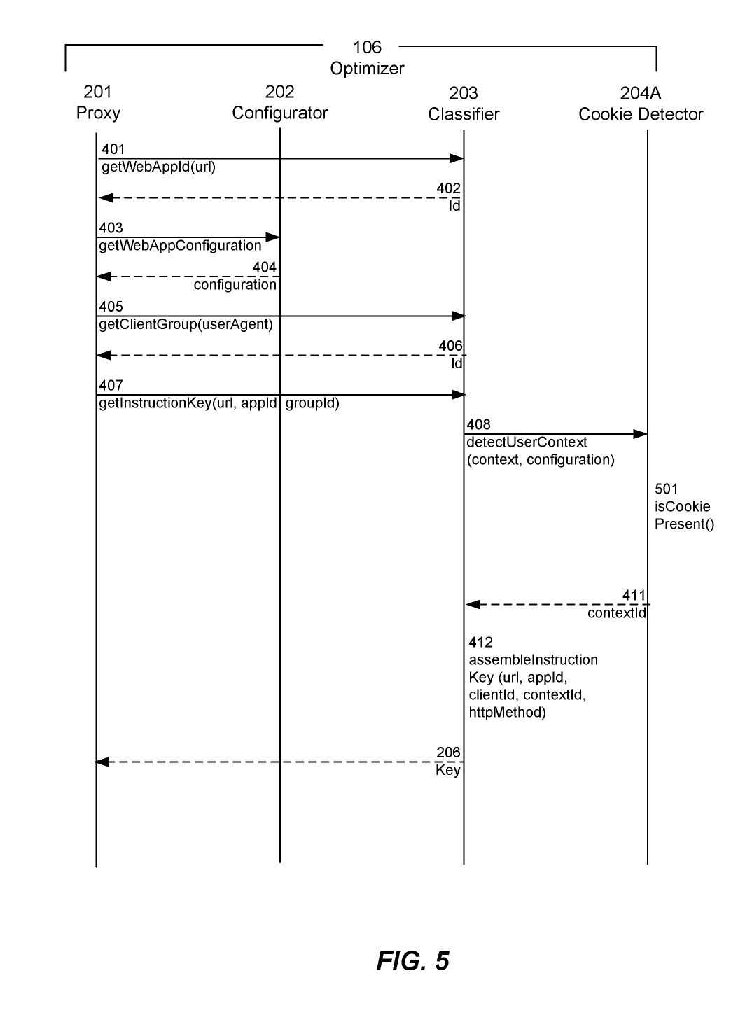

Referring now to FIG. 5, there is shown a sequence diagram illustrating an embodiment of user context scenario detection in which the presence or absence of a cookie is used to determine whether user 307 has previously visited the website and browser cache 111 has not been flushed in the interim. As is known in the art, a cookie is a mechanism by which a browser 112 can store information at a client 151, generally under the direction of a website. Subsequent requests from the client 151 indicate whether a cookie has previously been stored at the client 151. Thus, in one embodiment of the present invention, if a cookie for a website is not present, then user 307 is assumed to be a first-time user 307A, and the response is given an acceleration instruction tailored for the first-time user scenario. If the cookie is present, then user 307 is assumed to be a returning user 307B, and the response is given an acceleration instruction tailored for the returning user scenario, which assumes, for example, that local cache 111 already contains resources associated with the website.

The method depicted in FIG. 5 is similar to that of FIG. 4, with the following exceptions and further specifications. Cookie detector 204A is shown in place of detector 204. In response to detect user context request 408, cookie detector 204A determines 501 whether a cookie is present in the request received from client 151. This is shown in FIG. 5 as an isCookiePresent( ) call. Cookie detector 204A provides context identifier 411 based on the results of determination 501, and classifier 203 assembles 412 the instruction key accordingly. In one embodiment, a fallback method may also be provided, as described above in connection with FIG. 4.

The cookie can either be persistent or session-based. With a persistent cookie, if user 307 closes browser 112 and then reopens browser 112 and navigates to the accelerated site, the returning user view scenario is detected.

### Referrer Detection

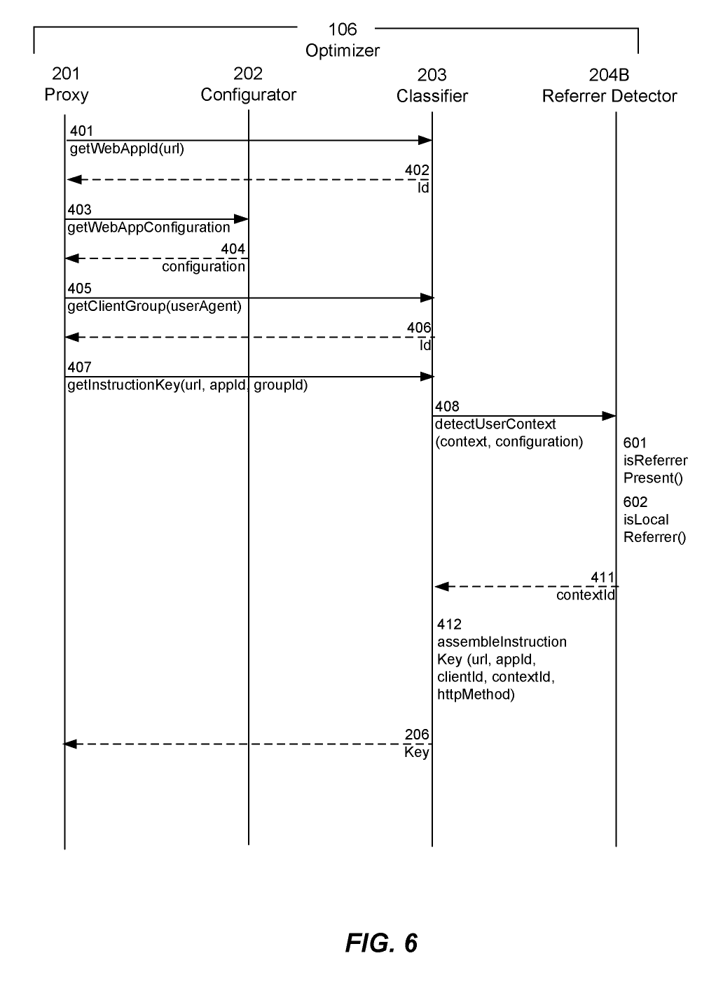

Referring now to FIG. 6, there is shown a sequence diagram illustrating an embodiment of user context scenario detection in which an HTTP referrer header is used to determine whether the user has previously visited the website and browser cache 111 has not been flushed in the interim.

HTTP referrer headers are a known technique for specifying, in a client request, the address (for example as a URL or URI) of a document (or element within a document) from which a URI or URL in the request was obtained. Thus, by checking an HTTP referrer header, server 110 can determine where a client request originated. The HTTP referrer header is defined in the HTTP RFC Reference at HTTP://www.w3.org/Protocols/HTTP/HTRQ_Headers.html#z14.

If the referrer header is absent or contains a URL indicating that user 307 has not previously visited the website, then user 307 is assumed to be a first-time user 307A, and the response is given an acceleration instruction tailored for the first-time user scenario (unless another form of detection indicates a previous visit to the site). If the referrer header is present and the URL indicates the referrer is likely on the same website as the current page request, then it is assumed that the referrer was another page within the same website. Any part of the URL can be used to make such a determination. Accordingly, user 307 is assumed to be a returning user 307B, and the response is given an acceleration instruction tailored for the repeat view scenario, which assumes, for example, that local cache 111 already contains resources associated with the website.

The method depicted in FIG. 6 is similar to that of FIG. 4, with the following exceptions and further specifications. Referrer detector 204B is shown in place of detector 204. In response to detect user context request 408, referrer detector 204B determines 601 whether an HTTP referrer header is present. If so, it determines 602 whether the HTTP referrer header indicates that the request originated from a local referrer. A local referrer may mean a page within the current site; alternatively it may mean a page within any site that has been optimized by optimizer 106. Referrer detector 204B provides context identifier 411 based on the results of determination 602, and classifier 203 assembles 412 the instruction key accordingly.

### Header Detection

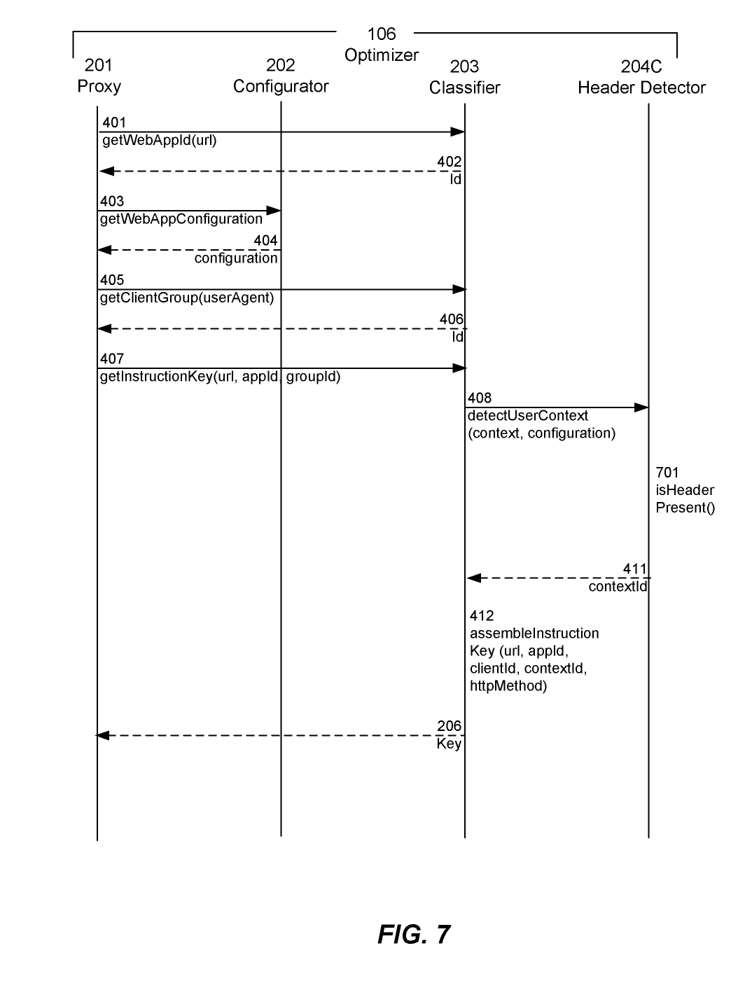

Referring now to FIG. 7, there is shown a sequence diagram illustrating an embodiment of user context scenario detection in which a configurable HTTP header is used to determine whether the user has previously visited the website and browser cache 111 has not been flushed in the interim.

If the HTTP header is absent, then the response is given an acceleration instruction tailored for the first-time user scenario (unless another form of detection indicates a previous visit to the site). If the header is present, then user 307 is assumed to be a returning user 307B, and the response is given an acceleration instruction tailored for the return user scenario, which assumes, for example, that local cache 111 already contains resources associated with the website.

In one embodiment, server 110 manages the insertion of the configurable header. In another embodiment the mechanism for inserting the header is implemented in an acceleration engine (accelerator), optimizer 106, or any other component that may be a component of server 110 or may be independent of server 110. For example, optimizer 106 can be configured, for example, to intercept all incoming and outgoing messages at server 110. In one embodiment, the component that inserts the header is implemented according to techniques described in related U.S. Utility application Ser. No. 12/426,909 for “Extensible, Asynchronous, Centralized Analysis and Optimization of Server Responses to Client Requests.”

The method depicted in FIG. 7 is similar to that of FIG. 4, with the following exceptions and further specifications. Header detector 204C is shown in place of detector 204. In response to detect user context request 408, header detector 204C determines 701 whether the configurable HTTP header is present. Header detector 204C provides context identifier 411 based on the results of determination 701, and classifier 203 assembles 412 the instruction key accordingly.

### ETag Detection

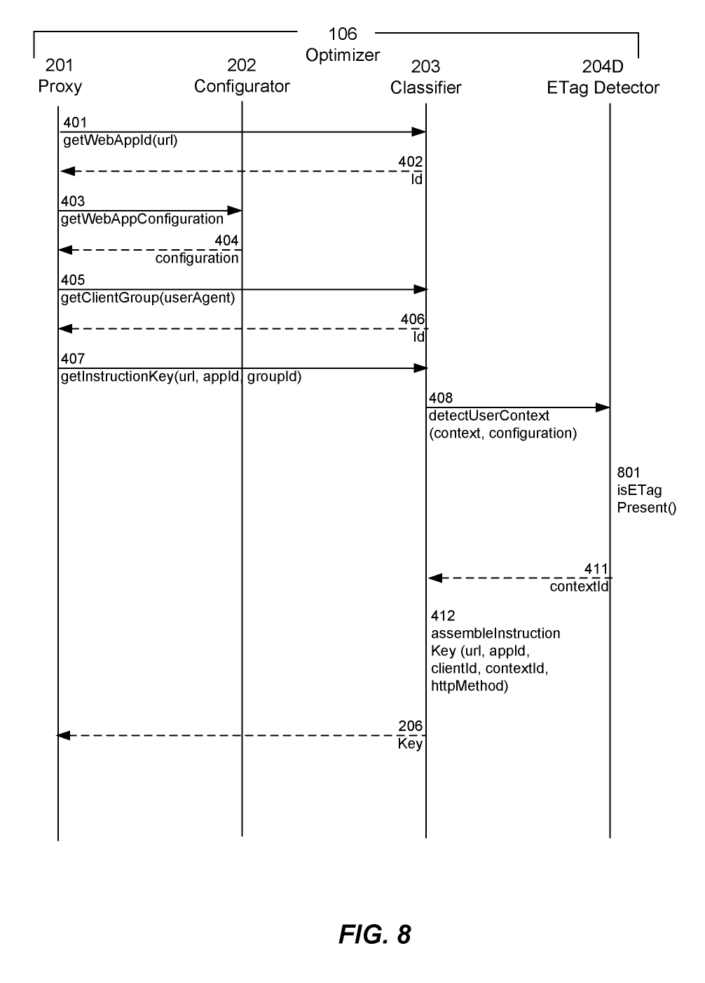

Referring now to FIG. 8, there is shown a sequence diagram illustrating an embodiment of user context scenario detection in which ETags are used to determine whether the user has previously visited the website and browser cache 111 has not been flushed in the interim.

An entity tag, or ETag, is an identifier assigned to a specific version of a resource found at a URL. The ETag may be assigned by server 110, by optimizer 106, or by any other entity. If the resource content at that URL changes, a different ETag is assigned. ETags accompany client requests for content. Accordingly, an ETag detected in a client request can be used to determine whether up-to-date resources are stored at cache 111 of a requesting client 151. Specifically, optimizer 106 can determine whether or not content at server 110 has changed since the resources were cached at client 151 (or if they have not yet been cached at all). Since ETags are generally flushed whenever a cache 111 is deleted, ETag detection can be a particularly reliable mechanism for ascertaining whether the user has previously visited the website and browser cache 111 has not been flushed in the interim.

As is known in the art, an ETag can be generated using a collision-resistant hash function of the content of the resource, or by any of a number of other mechanisms.

The method depicted in FIG. 8 is similar to that of FIG. 4, with the following exceptions and further specifications. ETag detector 204D is shown in place of detector 204. In response to detect user context request 408, ETag detector 204D determines 801 whether an ETag is present in the client request, and if so, optionally also determines whether the ETag matches current content at server 110. ETag detector 204D provides context identifier 411 based on the results of determination 801, and classifier 203 assembles 412 the instruction key accordingly.

### Request by First-Time User

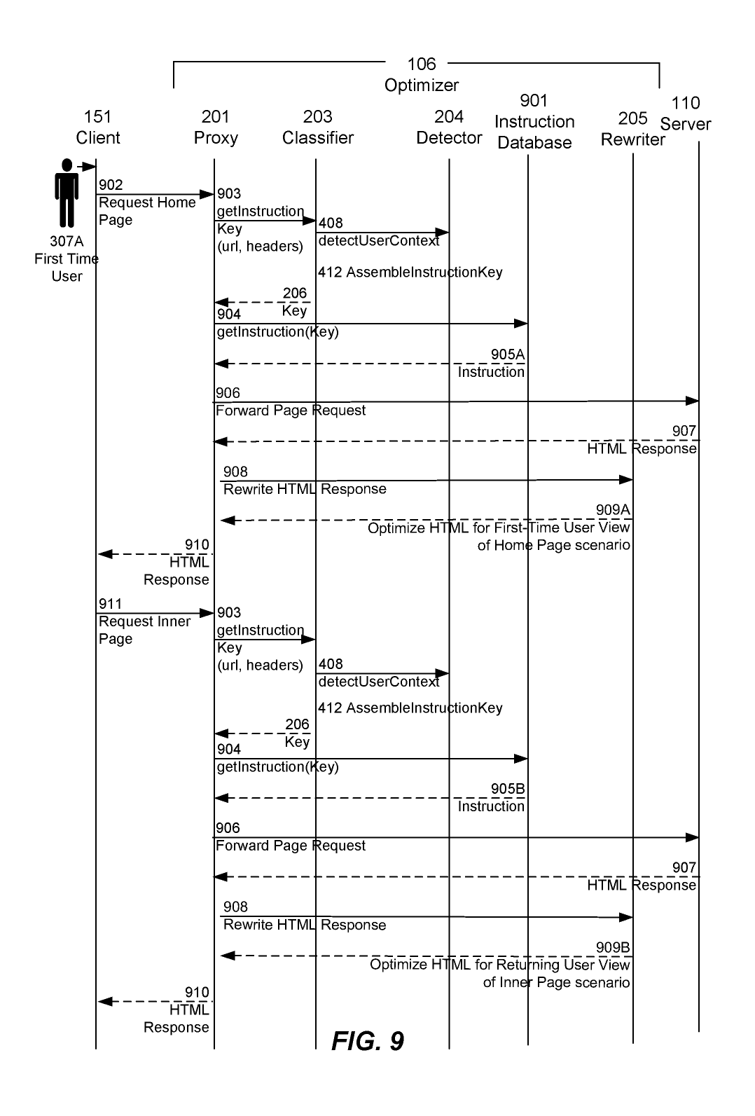

Referring now to FIG. 9, there is shown a sequence diagram illustrating the use of a user context scenario detection mechanism within an acceleration environment, wherein the user is a first-time user 307A, according to one embodiment. In the depicted usage scenario, user 307A is initially visiting an optimized website for the first time. FIG. 9 depicts handling of an initial request 902 for a home page and a subsequent request 911 for an inner page, including application of unique acceleration instructions that are tailored to the respective user contexts.

As described previously, proxy 201, classifier 203, detector 204, and rewriter 205 are, in one embodiment, components of optimizer 106, which may be located at router 108, or at server 110, or at any other location where it can intercept and modify HTTP requests passing between client 151 and server 110. For clarity, configurator 202 is omitted from FIG. 9.

In addition, FIG. 9 depicts instruction database 901, which is a data store, implemented on any suitable storage device, containing optimization instructions applicable to the current scenario that can be applied based on an instruction key. Optimization instructions can specify any available acceleration techniques, including, for example: dictionary compression; standardized SSL (Secure Sockets Layer) protocol encryption; tailored HTML response rewriting; modifying, adding, or removing response headers; consolidating resources into shared containers; placing resources inline with the response; aliasing resources; renaming resources; modifying, adding, or removing resources; modifying, adding, or removing references to resources; and the like. Optimization instructions can be implemented singly or in any operable combination. Further examples of optimization instructions can be found in related U.S. Utility application Ser. No. 12/426,909 for “Extensible, Asynchronous, Centralized Analysis and Optimization of Server Responses to Client Requests.”

In one embodiment, optimization instructions can be generated based on configuration information and an instruction key. In such an embodiment, instruction database 901 can be omitted.

Thus, according to the techniques of the present invention, a wide and extensible variety of acceleration techniques can be defined in the configuration and then optionally applied to each response with this technique, based on the detected user context scenario. In particular, for example, optimization instructions for a first-time user may specify that additional resources should be transmitted to client 151 so that they can be stored locally in cache 111 in order to improve response times for future page requests. Consolidation of such resources can also be performed if appropriate.

When proxy 201 receives 902 the HTTP request for a home page (or any such other page as the user may request) from user's 307 client machine 151, proxy 201 invokes 903 classifier 203 to obtain optimization instruction key 206 to use for the request. As described above in connection with FIG. 4, the step of obtaining optimization instruction key 206, can, in one embodiment, be performed by classifier 203 in response to receiving a call from proxy 201. Classifier detects 408 user context by making the appropriate call to detector 204, and assembles 412 instruction key 206 to be returned to proxy 201. Instruction key 206 maps the request to the best-fit acceleration instruction, taking into account the user context.

Proxy 201 obtains the identified instructions by calling 904 instruction database 901 with the scenario-specific acceleration instruction key, and receiving 905A instruction(s) in return. Alternatively, instructions can be generated “on-the-fly” using the acceleration instruction key without reference to an instruction database.

Proxy forwards 906 the page request to server 110 and receives 907 an HTML response. Proxy 201 then calls 908 rewriter 205 to rewrite the HTML response according to the optimization instructions. In one embodiment, proxy 201 passes the HTML response and the applicable optimization instructions (generated “on-the-fly” and/or retrieved from database 901) to rewriter 205 so that rewriter can rewrite the HTML response accordingly. Rewriter 205 performs the optimization process, using the acceleration technique(s) defined in the optimization instruction(s) that are passed to it. Rewriter returns 909A optimized HTML, which in this example has been optimized for a first-time user view of a home page (or any such other page as the user may have requested) of a website. Proxy 201 then returns 910 the HTML response to user's 307A client machine 151. Client machine 151 renders output for display at a display device, presenting the web page to user 307A.

Request 911 for an inner page of the website are handled similarly, although different optimization instruction(s) 905B would likely apply, so that rewriter returns 909B optimized HTML for a returning user view of an inner page. Some examples of how pages might be optimized for returning visitors optionally may include: referring to resources by a unique name which is anticipated to be in cache 111; avoiding unnecessarily including in the response resources which are anticipated to be in cache 111; consolidating resources used on this page that are rarely used on other pages; and the like.

### Request by Returning User

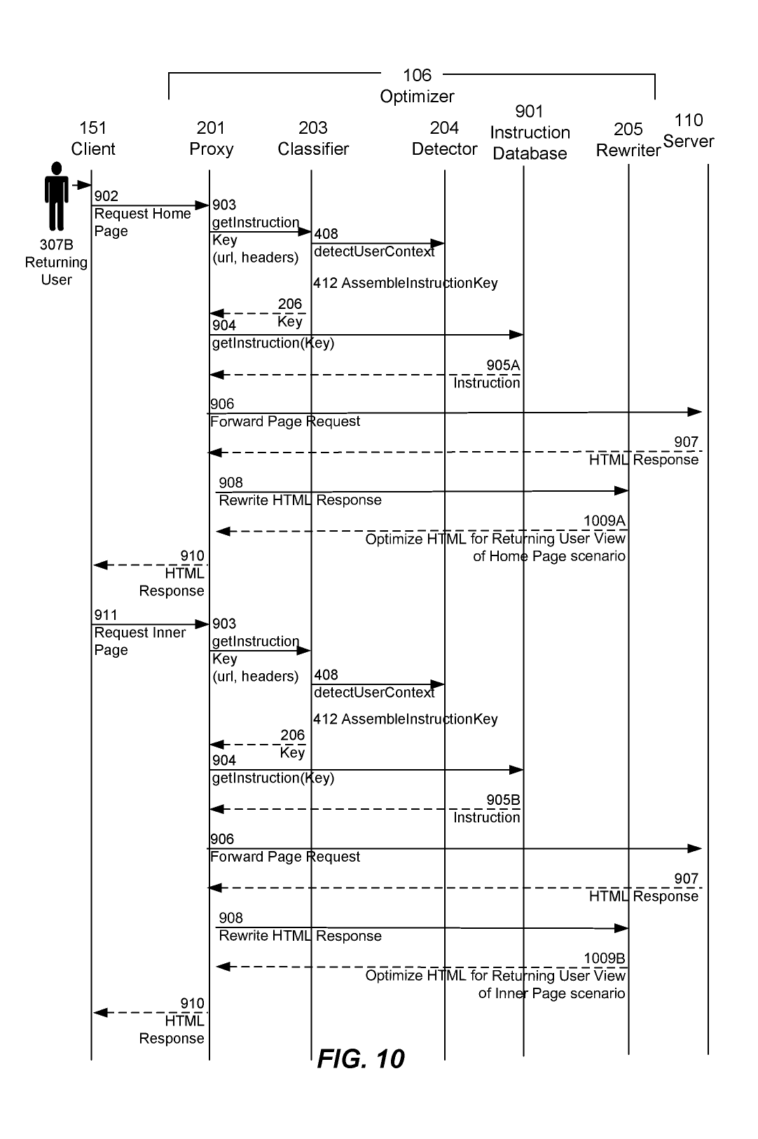

Referring now to FIG. 10, there is shown a sequence diagram illustrating the use of a user context scenario detection mechanism within an acceleration environment, wherein the user is a returning user 307B, according to one embodiment. The method of FIG. 10 is similar to that described above in connection with FIG. 9; however, in this use case, user 307B has previously visited the optimized site and a detector mechanism (such as a persistent cookie) is being used to determine the user context scenario. Again, for clarity, configurator 202 is omitted from FIG. 10.

FIG. 10 depicts handling of an initial request 902 for a home page and a subsequent request 911 for an inner page, including application of unique acceleration instructions that are tailored to the respective user contexts. For example, the first view of the home page in the illustrated scenario results in use of the returning user view optimization to accelerate the response, because the presence of the persistent cookie indicates that the user has previously visited the site. Accordingly, in the method of FIG. 10, instructions 905A and 905B specify optimization(s) applicable to a returning user view, and responses 1009A and 1009B from rewriter 205 contain optimized HTML for a returning user view of the home page and an inner page, respectively. One example of an optimization instruction would be to employ resources stored locally at browser cache 111 from a previous request.

Request 911 for an inner page of the website are handled similarly to those for a home page. In the example of FIG. 10, optimization instructions 905A, 905B would likely be similar to one another, since both user contexts are similar (a returning user). However, other factors may indicate some differences between optimization instructions 905A, 905B.

The techniques of the present invention can be applied to many situations in which it is beneficial to provide and apply different optimization mechanisms depending on user context. For example, and without limitation, the techniques described herein can be applied to an HTML page provided to a client machine 151 in response to a user request, wherein resources are included inline with the HTML page. Browser 112 displays the HTML page, including the included resources, to allow user 307 to start interacting with the page. A subsequent background request is made for the same resources using a regular HTTP request. Server 110 responds to the request. Resources provided in response to the background request are used to populate local cache 111. For subsequent page requests, the resources can be retrieved directly from local cache 111 rather than requested from server 110. As described above, optimization instructions specify when and how resources should be requested, provided, and/or combined when responding to client requests.

The present invention has been described in particular detail with respect to possible embodiments. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

In various embodiments, the present invention can be implemented as a system or a method for performing the above-described techniques, either singly or in any combination. In another embodiment, the present invention can be implemented as a computer program product comprising a nontransitory computer-readable storage medium and computer program code, encoded on the medium, for causing a processor in a computing device or other electronic device to perform the above-described techniques.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the above are presented in terms of algorithms and symbolic representations of operations on data bits within a memory of a computing device. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention can be embodied in software, firmware and/or hardware, and when embodied in software, can be downloaded to reside on and be operated from different platforms used by a variety of operating systems.

The present invention also relates to an apparatus for performing the operations herein. This apparatus may be specially constructed for the required purposes, or it may comprise a general-purpose computing device selectively activated or reconfigured by a computer program stored in the computing device. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, flash memory, solid state drives, magnetic or optical cards, application specific integrated circuits (ASICs), or any type of media suitable for storing electronic instructions, and each coupled to a computer system bus. Further, the computing devices referred to herein may include a single processor or may be architectures employing multiple processor designs for increased computing capability.

The algorithms and displays presented herein are not inherently related to any particular computing device, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description provided herein. In addition, the present invention is not described with reference to any particular programming language. It will be appreciated that a variety of programming languages may be used to implement the teachings of the present invention as described herein, and any references above to specific languages are provided for disclosure of enablement and best mode of the present invention.

Accordingly, in various embodiments, the present invention can be implemented as software, hardware, and/or other elements for controlling a computer system, computing device, or other electronic device, or any combination or plurality thereof. Such an electronic device can include, for example, a processor, an input device (such as a keyboard, mouse, touchpad, trackpad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or nonportable. Examples of electronic devices that may be used for implementing the invention include: a mobile phone, personal digital assistant, smartphone, kiosk, server computer, enterprise computing device, desktop computer, laptop computer, tablet computer, consumer electronic device, television, set-top box, or the like. An electronic device for implementing the present invention may use any operating system such as, for example: Linux; Microsoft Windows, available from Microsoft Corporation of Redmond, Wash.; Mac OS X, available from Apple Inc. of Cupertino, Calif.; iOS, available from Apple Inc. of Cupertino, Calif.; and/or any other operating system that is adapted for use on the device.

While the invention has been described with respect to a limited number of embodiments, those skilled in the art, having benefit of the above description, will appreciate that other embodiments may be devised which do not depart from the scope of the present invention as described herein. In addition, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the claims.

What is claimed is:

1. A computer-implemented method for optimizing a response to a content request in a client/server environment, comprising:
in a computing device, performing the steps of:
receiving, from a client, a request for content;
determining a user context scenario for the content request;
identifying at least one optimization instruction based on the determined user context scenario;
applying the identified at least one optimization instruction to a response received from a server, to generate a modified response; and
transmitting the modified response to the client.

2. The method of claim 1, wherein determining a user context scenario for the content request comprises determining a current state of a cache associated with the client.

3. The method of claim 1, wherein the requested content is associated with a website, and wherein determining a user context scenario for the content request comprises determining whether the client has previously visited the website.

4. The method of claim 1, wherein the requested content is associated with a website, and wherein determining a user context scenario for the content request comprises determining a likelihood that a cache associated with the client contains at least one stored resource for the website.

5. The method of claim 1, wherein the requested content is associated with a website, and wherein determining a user context scenario for the content request comprises determining whether the client has visited the website at any time since deletion of a cache associated with the client.

6. The method of claim 1, wherein the requested content is associated with a website, and wherein determining a user context scenario for the content request comprises determining whether the content request corresponds to a first-time user view of a page of the website.

7. The method of claim 1, wherein the steps of receiving, determining, identifying, applying, and transmitting are performed at an optimizer.

8. The method of claim 7, wherein the optimizer is implemented as a component of a router configured to route transmissions between the client and the server.

9. The method of claim 7, wherein the optimizer is implemented as a component of the server.

10. The method of claim 7, wherein the optimizer is implemented as a network device configured to intercept transmissions between the client and the server.

11. The method of claim 1, wherein:
identifying at least one optimization instruction comprises generating at least one instruction key; and
applying the identified at least one optimization instruction comprises:
using the generated instruction key to retrieve at least one optimization instruction from an instruction database; and
rewriting the receiving response according to the retrieved at least one optimization instruction.

12. The method of claim 1, wherein:
identifying at least one optimization instruction comprises generating at least one instruction key; and
applying the identified at least one optimization instruction comprises:
generating at least one optimization instruction using the generated instruction key; and
rewriting the receiving response according to the generated at least one optimization instruction.

13. The method of claim 1, wherein the requested content is associated with a website, and wherein applying the identified at least one optimization instruction comprises:
in response to the user context scenario indicating that the client is a first-time user with respect to the website, causing the modified response to include external resources for caching at the client.

14. The method of claim 1, wherein the requested content is associated with a website, and wherein applying the identified at least one optimization instruction comprises:
in response to the user context scenario indicating that the client is a returning user with respect to the website, causing the modified response to omit external resources likely to have been previously cached at the client.

15. The method of claim 1, wherein determining a user context scenario for the content request comprises:
identifying a web application associated with the request for content;
obtaining a configuration for the identified web application; and
determining a user context scenario based on the obtained configuration.

16. The method of claim 15, wherein the requested content is associated with a website, and wherein determining a user context scenario for the content request comprises determining whether the received request indicates a stored cookie relating to the website.

17. The method of claim 15, wherein the requested content is associated with a website, and wherein determining a user context scenario for the content request comprises determining whether the received request includes a referrer header having a URL indicating a previous visit to the website.

18. The method of claim 15, wherein the requested content is associated with a website, and wherein determining a user context scenario for the content request comprises determining whether the received request includes a header indicating a previous visit to the website.

19. The method of claim 15, wherein the requested content is associated with a website, and wherein determining a user context scenario for the content request comprises determining whether the received request includes an entity tag indicating that content associated with the website is cached at the client.

20. The method of claim 15, wherein receiving a request for content comprises intercepting a client request for content addressed to a server.

21. The method of claim 1, wherein at least one optimization instruction comprises an instruction to consolidate resources and transmit the consolidated resources to the client.

22. A computer program product for optimizing a response to a content request in a client/server environment, comprising:
a nontransitory computer-readable storage medium; and
computer program code, encoded on the medium, for causing at least one processor to perform the steps of:
receiving, from a client, a request for content;
determining a user context scenario for the content request;
identifying at least one optimization instruction based on the determined user context scenario;
applying the identified at least one optimization instruction to a response received from a server, to generate a modified response; and
transmitting the modified response to the client.

23. The computer program product of claim 22, wherein the computer program code for determining a user context scenario for the content request comprises computer program code for determining a current state of a cache associated with the client.

24. The computer program product of claim 22, wherein the requested content is associated with a website, and wherein the computer program code for determining a user context scenario for the content request comprises computer program code for determining whether the client has previously visited the website.

25. The computer program product of claim 22, wherein the requested content is associated with a website, and wherein the computer program code for determining a user context scenario for the content request comprises computer program code for determining a likelihood that a cache associated with the client contains at least one stored resource for the website.

26. The computer program product of claim 22, wherein the requested content is associated with a website, and wherein the computer program code for determining a user context scenario for the content request comprises computer program code for determining whether the client has visited the website at any time since deletion of a cache associated with the client.

27. The computer program product of claim 22, wherein the requested content is associated with a website, and wherein the computer program code for applying the identified at least one optimization instruction comprises:
computer program code for, in response to the user context scenario indicating that the client is a first-time user with respect to the website, causing the modified response to include external resources for caching at the client.

28. The computer program product of claim 22, wherein the requested content is associated with a website, and wherein the computer program code for applying the identified at least one optimization instruction comprises:
computer program code for, in response to the user context scenario indicating that the client is a returning user with respect to the website, causing the modified response to omit external resources likely to have been previously cached at the client.

29. A system for optimizing a response to a content request in a client/server environment, comprising:
a proxy, configured to receive, from a client, a request for content;
a user context scenario detector, communicatively coupled to the proxy and configured to determine a user context scenario for the content request;
a classifier, communicatively coupled to the user context scenario detector and configured to identify at least one optimization instruction based on the determined user context scenario; and
a rewriter, communicatively coupled to the classifier and configured to apply the identified at least one optimization instruction to a response received from a server, to generate a modified response;
wherein the proxy transmits the modified response to the client.

30. The system of claim 29, wherein the user context scenario detector is configured to determine the user context scenario by determining a current state of a cache associated with the client.

31. The system of claim 29, wherein the requested content is associated with a website, and wherein the user context scenario detector is configured to determine the user context scenario by determining whether the client has previously visited the website.

32. The system of claim 29, wherein the requested content is associated with a website, and wherein the user context scenario detector is configured to determine the user context scenario by determining a likelihood that a cache associated with the client contains at least one stored resource for the website.

33. The system of claim 29, wherein the requested content is associated with a website, and wherein the user context scenario detector is configured to determine the user context scenario by determining whether the client has visited the website at any time since deletion of a cache associated with the client.

34. The system of claim 29, wherein the requested content is associated with a website, and wherein the user context scenario detector is configured to determine the user context scenario by determining whether the content request corresponds to a first-time user view of a page of the website.

35. The system of claim 29, wherein the proxy, the user context scenario detector, the classifier, and the rewriter are implemented as components of an optimizer.

36. The system of claim 35, wherein the optimizer is implemented as a component of a router configured to route transmissions between the client and the server.

37. The system of claim 35, wherein the optimizer is implemented as a component of the server.

38. The system of claim 35, wherein the optimizer is implemented as a network device configured to intercept transmissions between the client and the server.

39. The system of claim 29, wherein:
the classifier is configured to identify at least one optimization instruction by generating at least one instruction key; and
the rewriter is configured to apply the identified at least one optimization instruction by:
using the generated instruction key to retrieve at least one optimization instruction from an instruction database; and
rewriting the receiving response according to the retrieved at least one optimization instruction.

40. The system of claim 29, wherein:
the classifier is configured to identify at least one optimization instruction by generating at least one instruction key; and
the rewriter is configured to apply the identified at least one optimization instruction by:
using the generated instruction key to generate at least one optimization instruction; and
rewriting the receiving response according to the generated at least one optimization instruction.

41. The system of claim 29, wherein the requested content is associated with a website, and wherein the rewriter is configured to apply the identified at least one optimization instruction by:
in response to the user context scenario indicating that the client is a first-time user with respect to the website, causing the modified response to include external resources for caching at the client.

42. The system of claim 29, wherein the requested content is associated with a website, and wherein the rewriter is configured to apply the identified at least one optimization instruction by:
in response to the user context scenario indicating that the client is a returning user with respect to the website, causing the modified response to omit external resources likely to have been previously cached at the client.

43. The system of claim 29, wherein the user context scenario detector is configured to determine a user context scenario for the content request by:
identifying a web application associated with the request for content;
obtaining a configuration for the identified web application; and
determining a user context scenario based on the obtained configuration.

44. The system of claim 43, wherein the requested content is associated with a website, and wherein the user context scenario detector is configured to determine a user context scenario for the content request by determining whether the received request indicates a stored cookie relating to the website.

45. The system of claim 43, wherein the requested content is associated with a website, and wherein the user context scenario detector is configured to determine a user context scenario for the content request by determining whether the received request includes a referrer header having a URL indicating a previous visit to the website.

46. The system of claim 43, wherein the requested content is associated with a website, and wherein the user context scenario detector is configured to determine a user context scenario for the content request by determining whether the received request includes a header indicating a previous visit to the website.

47. The system of claim 43, wherein the requested content is associated with a website, and wherein the user context scenario detector is configured to determine a user context scenario for the content request by determining whether the received request includes an entity tag indicating that content associated with the website is cached at the client.

48. The system of claim 43, wherein the proxy is configured to receive the request for content by intercepting a client request for content addressed to a server.

49. The system of claim 29, wherein at least one optimization instruction comprises an instruction to consolidate resources and transmit the consolidated resources to the client.
